(19) United States
(12) Patent Application Publication
(10) Pub. No.: US 2015/0201398 A1
(43) Pub. Date: Jul. 16, 2015

(54) OPTIMIZED CAMPING ON A CELL

(71) Applicant: QUALCOMM Incorporated, San Diego, CA (US)

(72) Inventors: Mungal Singh Dhanda, Slough (GB); Divaydeep Sikri, Farnborough (GB)

(73) Assignee: QUALCOMM Incorporated, San Diego, CA (US)

(21) Appl. No.: 14/152,202

(22) Filed: Jan. 10, 2014

(51) Int. Cl. H04W 68/02; H04W 48/10; H04W 52/02; H04W 36/00

(52) U.S. Cl. CPC H04W 68/02; H04W 36/0016; H04W 48/10; H04W 52/0212; H04W 88/02

(57) ABSTRACT

Embodiments of the present invention include devices, systems and methods for optimized camping on a cell. One method can include beginning a connection via a first cell. The method also includes participating in a handover to a second cell. The method further includes tuning away from a traffic channel to a broadcast control channel. A system information message is received via the broadcast control channel. The method also includes tuning back to the traffic channel to continue the connection. Other aspects, embodiments and features are also claimed and described.

### TECHNICAL FIELD

The technology discussed below relates generally to communication systems, and more specifically to systems and methods for optimized camping on a cell. Implementation of embodiments of the technology can be used to enable efficient power consumption, minimize missed pages for call subscriptions and minimize impact to other subscriptions supported by a mobile station.

### BACKGROUND

Users of wireless communication devices desire that their devices have many features. For example, a user may expect to power on a wireless communication device and immediately make or receive a phone call. However, wireless communication devices must perform initial acquisition and camp-on procedures before service can be obtained and wireless communications can be established. Those procedures may need to be performed at power-on and whenever a wireless communication device leaves a service area and then returns to a service area. These procedures may require considerable amounts of time before a user can make a phone call.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A method for wireless communication by a wireless communication device is described. The wireless communication device begins a connection via a first cell. The wireless communication device participates in a handover to a second cell. The wireless communication device tunes away from a traffic channel to a broadcast control channel. A system information message is received via the broadcast control channel. The wireless communication device tunes back to the traffic channel to continue the connection.

The system information message may be a system information type 3 message. The wireless communication device may camp on the second cell in normal paging mode immediately after the connection ends. No more than four bursts of traffic information may be missed on the traffic channel while the wireless communication device is tuned to the broadcast control channel. The tuning away may be done in such a manner as to minimize disruption to the connection. The connection may be a voice call that uses one of half-rate traffic channels and full-rate traffic channels. The connection may be used for signaling. The connection may be a standalone dedicated channel.

The wireless communication device may start to monitor a computed paging sub-channel. Frame number information for the second cell may be determined from channels used in the connection. The frame number information may be used to determine when to tune away from the traffic channel to the broadcast control channel. The connection may be a circuit switched connection.

An apparatus for wireless communication is also described. The apparatus includes a processor, memory in electronic communication with the processor and instructions stored in the memory. The instructions are executable by the processor to begin a connection via a first cell. The instructions are also executable by the processor to participate in a handover to a second cell. The instructions are further executable by the processor to tune away from a traffic channel to a broadcast control channel. The instructions are also executable by the processor to receive a system information message via the broadcast control channel. The instructions are further executable by the processor to tune back to the traffic channel to continue the connection.

A wireless device is also described. The wireless device includes means for beginning a connection via a first cell. The wireless device also includes means for participating in a handover to a second cell. The wireless device further includes means for tuning away from a traffic channel to a broadcast control channel. The wireless device also includes means for receiving a system information message via the broadcast control channel. The wireless device further includes means for tuning back to the traffic channel to continue the connection.

A computer-program product for wireless communications is described. The computer-program product includes a non-transitory computer-readable medium having instructions thereon. The instructions include code for causing a wireless communication device to begin a connection via a first cell. The instructions also include code for causing the wireless communication device to participate in a handover to a second cell. The instructions further include code for causing the wireless communication device to tune away from a traffic channel to a broadcast control channel. The instructions also include code for causing the wireless communication device to receive a system information message via the broadcast control channel. The instructions further include code for causing the wireless communication device to tune back to the traffic channel to continue the connection.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 shows a wireless communication system with multiple wireless devices according to some embodiments;

FIG. 2 is a block diagram illustrating a 51-frame multiframe for use in the present systems and methods;

FIG. 3 shows example frame and burst formats in GSM;

FIG. 4 is a flow diagram of a method for optimized camping on a cell according to some embodiments;

FIG. 5 is a block diagram illustrating tuning away from the traffic channel to the broadcast control channel (BCCH) to receive a system information type 3 (SI3) message during a dedicated connection according to some embodiments; and

FIG. 6 illustrates certain components that may be included within a wireless communication device according to some embodiments.

### DETAILED DESCRIPTION

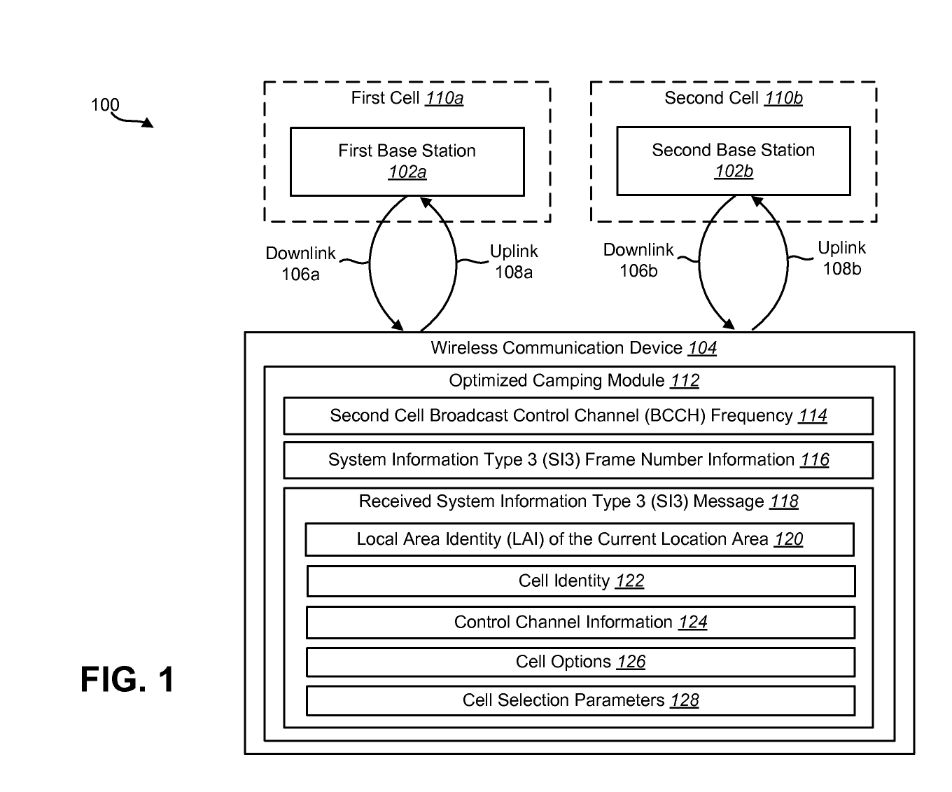

FIG. 1 shows a wireless communication system 100 with multiple wireless devices according to some embodiments. Wireless communication systems 100 are widely deployed to provide various types of communication content such as voice, data and so on. A wireless device may be a base station 102 or a wireless communication device 104. The wireless communication device 104 may be configured for optimized camping on a cell. For example, the wireless communication device 104 may be configured to determine (during a dedicated connection) the common control channel configuration of a new serving cell (e.g., the second cell 110b) after handing over from an old serving cell (e.g., the first cell 110a). This may allow the wireless communication device 104 to camp on the second cell 110b in normal paging mode after the dedicated connection ends without undue delay.

A base station 102a-b is a station that communicates with one or more wireless communication devices 104. A base station 102 may also be referred to as, and may include some or all of the functionality of, an access point, a base transceiver station (BTS), a broadcast transmitter, a NodeB, an evolved NodeB, etc. The term “base station” will be used herein. Each base station 102 provides communication coverage for a particular geographic area. A base station 102 may provide communication coverage for one or more wireless communication devices 104. The term “cell” can refer to a base station 102 and/or its coverage area depending on the context in which the term is used.

Communications in a wireless communication system 100 (e.g., a multiple-access system) may be achieved through transmissions over a wireless link. Such a communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may utilize MIMO. A MIMO system may support both time division duplex (TDD) and frequency division duplex (FDD) systems. In a TDD system, uplink and downlink transmissions are in the same frequency region so that the reciprocity principle allows the estimation of the downlink channel from the uplink channel. This enables a transmitting wireless device to extract transmit beamforming gain from communications received by the transmitting wireless device.

The wireless communication system 100 may be a multiple-access system capable of supporting communication with multiple wireless communication devices 104 by sharing the available system resources (e.g., bandwidth and transmit power). Examples of such multiple-access systems include code division multiple access (CDMA) systems, wideband code division multiple access (WCDMA) systems, time division multiple access (TDMA) systems, frequency division multiple access (FDMA) systems, orthogonal frequency division multiple access (OFDMA) systems, single-carrier frequency division multiple access (SC-FDMA) systems, 3^{rd} Generation Partnership Project (3GPP) Long Term Evolution (LTE) systems and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes WCDMA and Low Chip Rate (LCR) while cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE), a wireless communication device 104 may be referred to as a “user equipment” (UE). A wireless communication device 104 may also be referred to as, and may include some or all of the functionality of, a terminal, an access terminal, a subscriber unit, a station, etc. A wireless communication device 104 may be a cellular phone, a personal digital assistant (PDA), a wireless device, a wireless modem, a handheld device, a laptop computer, entertainment device, wearable device, television, computing device, and many other types of devices capable of wireless communication.

A wireless communication device 104 may communicate with zero, one or multiple base stations 102 on the downlink 106a-b and/or uplink 108a-b at any given moment. The downlink 106 (or forward link) refers to the communication link from a base station 102 to a wireless communication device 104, and the uplink 108 (or reverse link) refers to the communication link from a wireless communication device 104 to a base station 102.

The Global System for Mobile Communications (GSM) is a widespread standard in cellular, wireless communication. GSM is relatively efficient for standard voice services. However, high-fidelity audio and data services require higher data throughput rates than that for which GSM is optimized. To increase capacity, the General Packet Radio Service (GPRS) and EDGE (Enhanced Data rates for GSM Evolution) standards have been adopted in GSM systems. In the GSM/EDGE Radio Access Network (GERAN) specification, GPRS and enhanced general packet radio service (EGPRS) provide data services. The standards for GERAN are maintained by the 3GPP (Third Generation Partnership Project). GERAN is a part of GSM. More specifically, GERAN is the radio part of GSM/EDGE together with the network that joins the base stations 102 (the Ater and Abis interfaces) and the base station controllers (A interfaces, etc.). GERAN represents the core of a GSM network. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM networks typically operate in a number of frequency bands. For example, a GSM network may use the GSM-850 band, the EGSM band (also referred to as the E-GSM-900 band), the DCS (digital cellular service) band (also referred to as DCS-1800), the PCS (personal communications service) band (also referred to as PCS-1900), the P-GSM band, the R-GSM band and the T-GSM band.

The wireless communication device 104 may include an optimized camping module 112. The optimized camping module 112 may allow the wireless communication device 104 to reduce the time needed to obtain the configuration of a new cell 110 after a handover. The wireless communication device 104 may handover from the first cell 110a to the second cell 110b during a circuit switched connection which may also be referred to as a dedicated connection. In one configuration, the dedicated connection may be used for a voice call. For example, the dedicated connection may use half-rate traffic channels or full-rate traffic channels for a voice call. In another configuration, the dedicated connection may be used for signaling. For example, the dedicated connection may be a standalone dedicated control channel (SDCCH). The dedicated connection may also be used for registration, Short Message Service (SMS) and Supplementary Services (SS).

In GERAN, when a voice call or other dedicated connection is handed off from a first cell 110a to a second cell 110b, the wireless communication device 104 may not know the configuration of the second cell 110b. Thus, after the dedicated connection is released in the second cell 110b (e.g., after the voice call ends or the call is dropped), the wireless communication device 104 needs to monitor the full common control channel (i.e., all the radio blocks) until the necessary system information type 3 (SI3) message 118 has been read that provides the parameters needed (which describe the common control channel configuration). The common control channel configuration may include parameters such as the number of common control channels used in the cell 110, the number of paging sub-channels used in the cell 110, the type of common control channels used (combined or non-combined), etc.

It can take up to 940 milliseconds (ms) for the wireless communication device 104 to acquire the system information type 3 (SI3) message 118 if radio conditions are good; otherwise it can take even longer. During this period, the wireless communication device 104 is consuming energy to read the full common control channel. In cases where multiple common control channels are supported by the second cell 110b, the wireless communication device 104 may be monitoring the wrong common control channel. For example, multiple common control channels are deployed in some parts of China. The wireless communication device 104 may monitor the wrong common control channel if the wireless communication device's international mobile subscriber identity (IMSI) and common control channel parameters indicate that the wireless communication device 104 is to monitor the common control channel on a different timeslot (e.g., timeslot 2, 4 or 6) than the default common control channel (e.g., timeslot 0) used by the second cell 110b.

During the 940 ms that the wireless communication device 104 may take to acquire the system information type 3 (SI3) message 118, the wireless communication device 104 may miss paging messages. Furthermore, if the wireless communication device 104 supports multiple subscriber identity module (SIM) cards (such as dual-SIM dual standby (DSDS) and tri-SIM tri-standby (TSTS)), then subscriptions other than the dedicated connection may not have enough time to read their own paging sub-channels because the radio is constantly being used by the subscription attempting to read the system information type 3 (SI3) message 118.

The optimized camping module 112 may know the broadcast control channel (BCCH) frequency 114 of the second cell 110b (which becomes the serving cell after the handover) because the wireless communication device 104 is communicating with the second base station 102b during the dedicated connection. From the channels that are used for the dedicated connection, the wireless communication device 104 already knows the system information type 3 (SI3) message frame number information 116 (i.e., the frame numbers when the system information type 3 (SI3) message 118 is transmitted). The system information type 3 (SI3) message 118 is sent every 940 ms on the broadcast control channel (BCCH). Four GSM frames are needed to transmit the system information type 3 (SI3) message 118 over the radio interface. Thus, the wireless communication device 104 can compute when the system information type 3 (SI3) message 118 will be broadcast by the network over the broadcast control channel (BCCH).

Rather than wait to receive the system information type 3 (SI3) message 118 from the second cell 110b until after the dedicated connection has ended, the wireless communication device 104 may tune away from the traffic channel of the dedicated connection (while the dedicated connection is still active) to the broadcast control channel (BCCH) to receive the system information type 3 (SI3) message 118 and then tune back to the traffic channel of the dedicated connection. Tuning away from the traffic channel may cause the wireless communication device 104 to miss at most four bursts of traffic information (that is lost on both the uplink and the downlink traffic channels). The loss of four bursts of traffic information during the dedicated connection (especially during a voice call) is unlikely to be noticed by users. The impact to the ongoing voice call can be minimized by employing burst level tune-away.

The received system information type 3 (SI3) message 118 may include parameters for the second cell 110b such as the local area identity (LAI) 120 of the current location area, the cell identity 122, the control channel information 124, the cell options 126 and the cell selection parameters 128.

When the dedicated connection is later released by the wireless communication device 104, the wireless communication device 104 can camp on the second cell 110b in normal paging mode (i.e., by starting to use discontinuous reception (DRx)). Optimized camping minimizes the impact of a handover during a dedicated connection to other subscriptions supported by the wireless communication device 104, reduces the energy consumption by the wireless communication device 104 during camping upon call release after a handover and reduces the probability of missing subsequent mobile terminated calls.

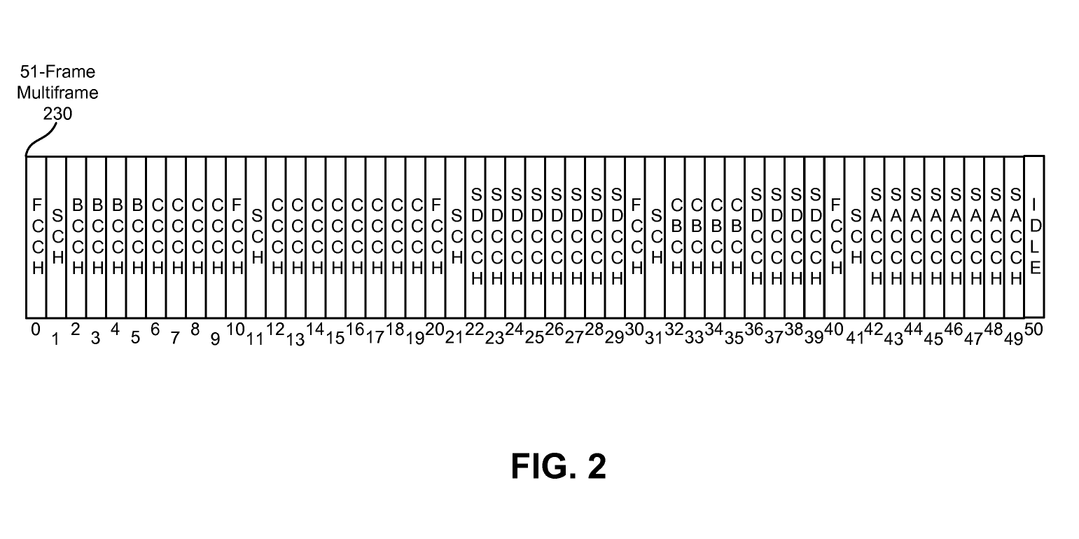

FIG. 2 is a block diagram illustrating a 51-frame multiframe 230 for use in the present systems and methods. Different channels may be mapped to different frames within the 51-frame multiframe 230. For example, the broadcast control channel (BCCH) may be mapped to frames 2 through 5. The mapping of the channels to specific frames may be fixed by the specification.

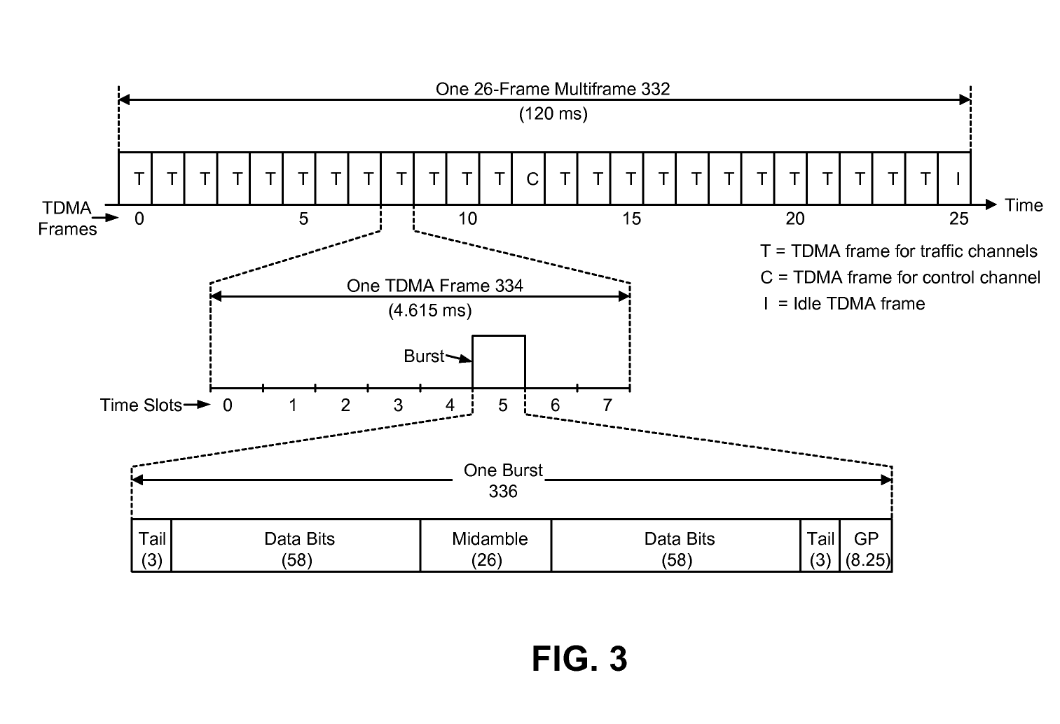

FIG. 3 shows example frame and burst formats in GSM. The timeline for transmission is divided into multiframes 332. For traffic channels used to transmit user-specific data, each multiframe 332 in this example includes 26 TDMA frames 334, which are labeled as TDMA frames 0 through 25. The traffic channels, in this example, are sent in TDMA frames 0 through 11 and TDMA frames 13 through 24 of each multiframe 332 (other mappings are possible using half-rate channels or Voice services over Adaptive Multi-user channels on One Slot (VAMOS)). A control channel is sent in TDMA frame 12. No data is sent in idle TDMA frame 25, which is used by the wireless communication devices 104 to make measurements of signals transmitted by neighbor base stations 102.

Each time slot within a frame is also referred to as a “burst” 336 in GSM. Each burst 336, in this example, includes two tail fields, two data fields, a training sequence (or midamble) field and a guard period (GP). The number of symbols in each field is shown inside the parentheses. A burst 336 includes symbols for the tail, data, and midamble fields. No symbols are sent in the guard period. TDMA frames of a particular carrier frequency are numbered and formed in groups of 26 or 51 TDMA frames 334 called multiframes 332.

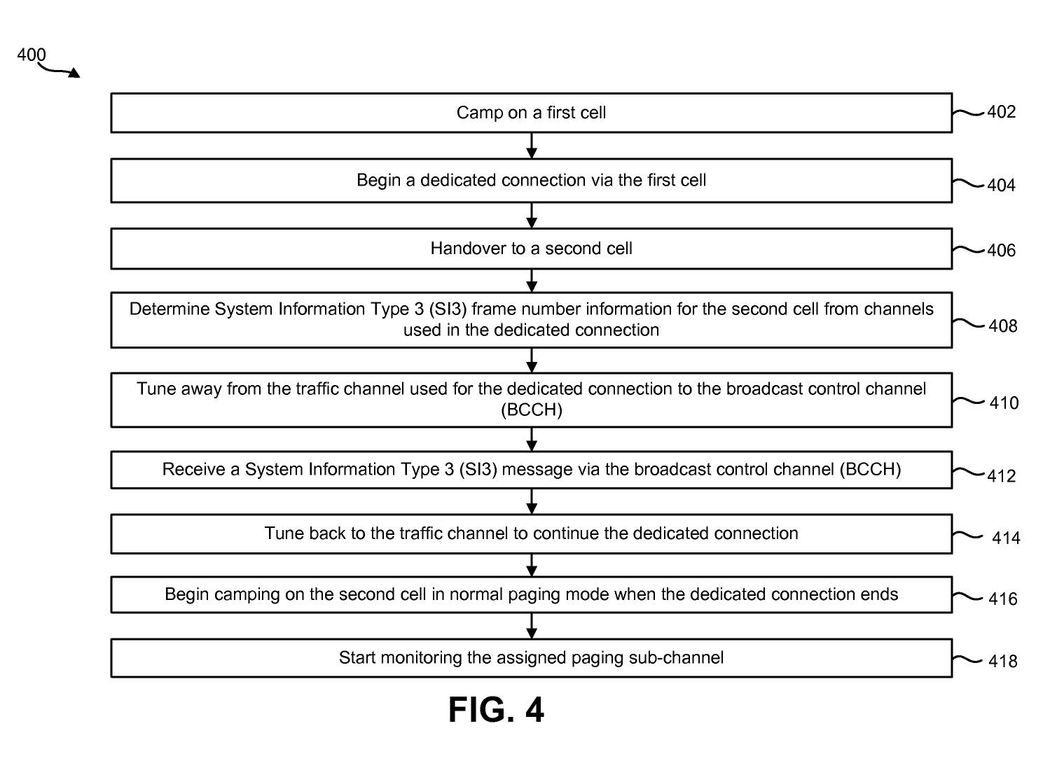

FIG. 4 is a flow diagram of a method 400 for optimized camping on a cell 110 according to some embodiments. The method 400 may be performed by a wireless communication device 104. For example, the method 400 may be performed by a processor on a wireless communication device 104. The wireless communication device 104 may include an optimized camping module 112. The wireless communication device 104 may camp 402 on a first cell 110a. The first cell 110a may include a first base station 102a. The wireless communication device 104 may begin 404 a dedicated connection via the first cell 110a. In one configuration, the dedicated connection may be used for a voice call or for signaling. If the dedicated connection is used for a voice call, the dedicated connection may use a half-rate traffic channel or a full-rate traffic channel. If the dedicated connection is used for signaling, the dedicated connection may use a standalone dedicated control channel (SDCCH).

During the dedicated connection, the wireless communication device 104 may handover 406 to a second cell 110b. The second cell 110b may include a second base station 102b. Thus, the second cell 110b may become the serving cell 110 for the wireless communication device 104. The wireless communication device 104 may determine 408 system information type 3 (SI3) frame number information 116 for the second cell 110b from channels used for the dedicated connection. The wireless communication device 104 may tune away 410 from the traffic channel used for the dedicated connection to the broadcast control channel (BCCH). The tuning away 410 may be done in a manner to minimize disruption to the dedicated connection. For example, the tuning away 410 may be performed quickly and/or at a time least likely to disrupt the dedicated connection.

The wireless communication device 104 may receive 412 a system information type message. The message may be a system information type 3 (SI3) message 118. The wireless communication device 104 may receive 412 the message via the broadcast control channel (BCCH). The system information type 3 (SI3) message 118 may be sent every 940 ms on the broadcast control channel (BCCH). It may require four TDMA frames 334 to transmit the system information type 3 (SI3) message 118 over the radio interface (i.e., 18.46 ms). While the wireless communication device 104 is receiving 412 the system information type 3 (SI3) message 118 via the broadcast control channel (BCCH), the wireless communication device 104 may miss traffic information on the uplink 108 and/or downlink 106 traffic channels. After receiving the system information type 3 (SI3) message 118 via the broadcast control channel (BCCH), the wireless communication device 104 may tune back 414 to the traffic channel to continue the dedicated connection.

The wireless communication device 104 may begin camping 416 on the second cell 110b in normal paging mode when the dedicated connection ends. For example, the wireless communication device 104 may start using discontinuous reception (DRx). The wireless communication device 104 does not need to monitor the complete common control channel (CCCH) until a system information type 3 (SI3) message 118 is received after the handover, since the system information type 3 (SI3) message 118 has already been received. This can reduce the energy consumption of the wireless communication device 104 and the probability of missing subsequent mobile terminated calls. The wireless communication device 104 may start monitoring 418 the assigned paging sub-channel.

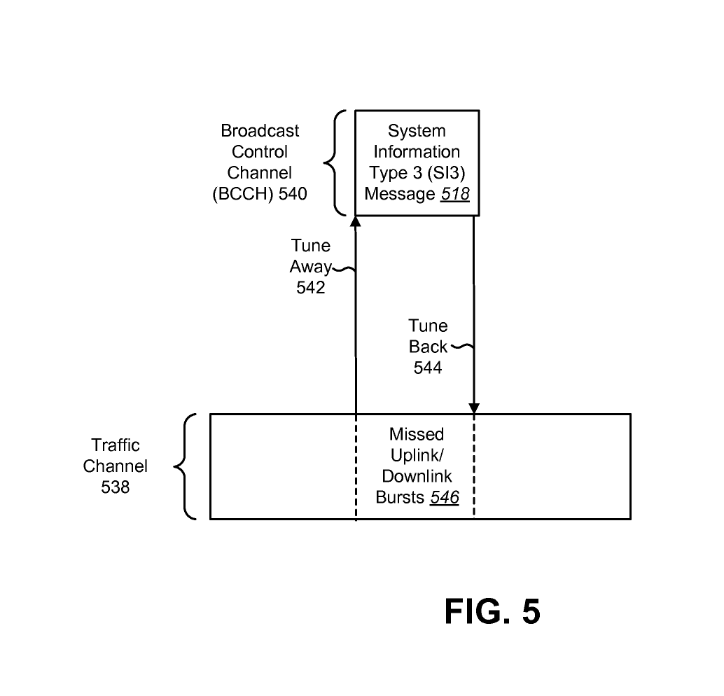

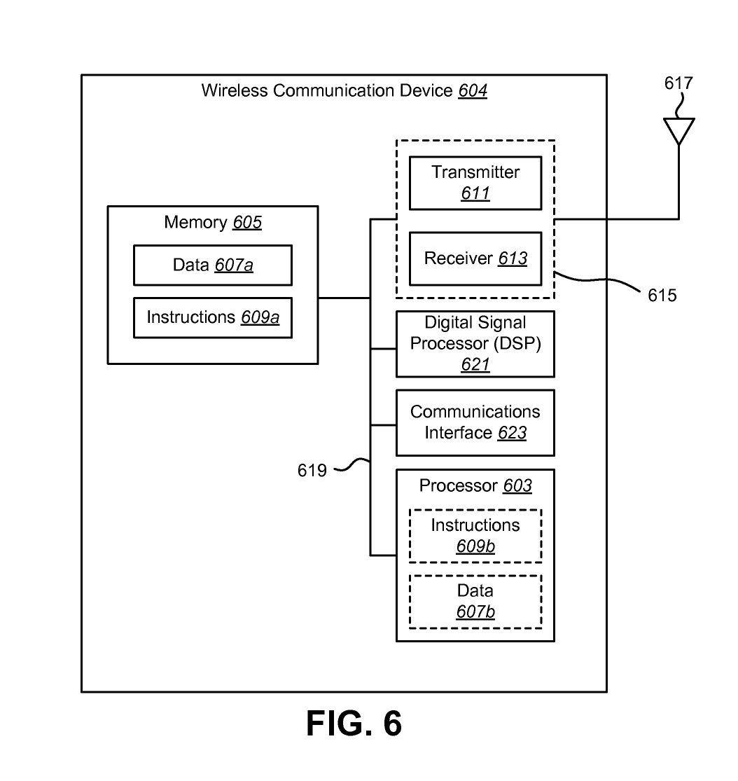

FIG. 5 is a block diagram illustrating tuning away from the traffic channel 538 to the broadcast control channel (BCCH) 540 to receive a system information type 3 (SI3) message 518 during a dedicated connection according to some embodiments. Both the traffic channel 538 (for the dedicated connection) and the broadcast control channel (BCCH) 540 are illustrated. The wireless communication device 104 (also discussed below in relation to FIG. 6) may have a dedicated connection that includes transmitting and receiving information via the traffic channel 538. Based on information received via the traffic channel 538, the wireless communication device 104 may be aware of the frames on the broadcast control channel (BCCH) 540 that will include the system information type 3 (SI3) message 518.

When the broadcast control channel (BCCH) 540 includes the system information type 3 (SI3) message 518, the wireless communication device 104 may tune away 542 from the traffic channel 538 to the broadcast control channel (BCCH) 540 to receive the system information type 3 (SI3) message 518. While the wireless communication device 104 is tuned away from the traffic channel 538, the wireless communication device 104 may miss uplink/downlink bursts 546 on the traffic channel 538. The tuning away 542 may be done in such a manner to minimize disruption to the dedicated connection. In one configuration, the wireless communication device 104 may miss up to four bursts 546 of traffic information on the traffic channel 538 when the wireless communication device 104 is tuned away to the broadcast control channel (BCCH) 540. Once the wireless communication device 104 has received the system information type 3 (SI3) message 518 via the broadcast control channel (BCCH) 540, the wireless communication device 104 may tune back 544 to the traffic channel 538 to continue the dedicated connection. In one configuration, the tune-away may be performed in such a manner that no disruption is experienced by the dedicated connection (e.g., using burst level tune-away). By receiving the system information type 3 (SI3) message 518 during the dedicated connection, the wireless communication device 104 may avoid having to receive the system information type 3 (SI3) message 518 once the dedicated connection has ended, resulting in power savings and improved user experience.

FIG. 6 illustrates certain components that may be included within a wireless communication device 604 according to some embodiments. The wireless communication device 604 of FIG. 6 may be one configuration of the wireless communication device 104 of FIG. 1. The wireless communication device 604 may be an access terminal, a mobile station, a user equipment (UE), etc. The wireless communication device 604 includes a processor 603. The processor 603 may be a general purpose single- or multi-chip microprocessor (e.g., an ARM), a special purpose microprocessor (e.g., a digital signal processor (DSP)), a microcontroller, a programmable gate array, etc. The processor 603 may be referred to as a central processing unit (CPU). Although just a single processor 603 is shown in the wireless communication device 604 of FIG. 6, in an alternative configuration, a combination of processors (e.g., an ARM and DSP) could be used.

The wireless communication device 604 also includes memory 605. The memory 605 may be any electronic component capable of storing electronic information. The memory 605 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 607a and instructions 609a may be stored in the memory 605. The instructions 609a may be executable by the processor 603 to implement the methods disclosed herein. Executing the instructions 609a may involve the use of the data 607a that is stored in the memory 605. When the processor 603 executes the instructions 609, various portions of the instructions 609b may be loaded onto the processor 603, and various pieces of data 607b may be loaded onto the processor 603. In one configuration, the processor 603 may include the optimized camping module 112 discussed above.

The wireless communication device 604 may also include a transmitter 611 and a receiver 613 to allow transmission and reception of signals to and from the wireless communication device 604 via an antenna 617. The transmitter 611 and receiver 613 may be collectively referred to as a transceiver 615. The wireless communication device 604 may also include (not shown) multiple transmitters, multiple antennas, multiple receivers and/or multiple transceivers.

The wireless communication device 604 may include a digital signal processor (DSP) 621. The wireless communication device 604 may also include a communications interface 623. The communications interface 623 may allow a user to interact with the wireless communication device 604.

The various components of the wireless communication device 604 may be coupled together by one or more buses, which may include a power bus, a control signal bus, a status signal bus, a data bus, etc. For the sake of clarity, the various buses are illustrated in FIG. 6 as a bus system 619.

The techniques described herein may be used for various communication systems, including communication systems that are based on an orthogonal multiplexing scheme. Examples of such communication systems include Orthogonal

Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 4, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized. For example, some of the methods described herein may be performed by a processor 603, software and/or firmware.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for wireless communication by a wireless communication device, comprising:
beginning a connection via a first cell;
participating in a handover to a second cell;
tuning away from a traffic channel to a broadcast control channel;
receiving a system information message via the broadcast control channel; and
tuning back to the traffic channel to continue the connection.

2. The method of claim 1, wherein the system information message is a system information type 3 message.

3. The method of claim 1, further comprising camping on the second cell in normal paging mode immediately after the connection ends.

4. The method of claim 1, wherein no more than four bursts of traffic information are missed on the traffic channel while the wireless communication device is tuned to the broadcast control channel.

5. The method of claim 1, wherein tuning away is done in such a manner as to minimize disruption to the connection.

6. The method of claim 1, wherein the connection is a voice call that uses one of half-rate traffic channels and full-rate traffic channels.

7. The method of claim 1, wherein the connection is used for signaling, and wherein the connection is a standalone dedicated channel.

8. The method of claim 1, further comprising starting to monitor a computed paging sub-channel.

9. The method of claim 1, further comprising determining frame number information for the second cell from channels used in the connection, wherein the frame number information is used to determine when to tune away from the traffic channel to the broadcast control channel.

10. The method of claim 1, wherein the connection is a circuit switched connection.

11. An apparatus for wireless communication, comprising:
a processor;
memory in electronic communication with the processor; and
instructions stored in the memory, the instructions being executable by the
processor to:
begin a connection via a first cell;
participate in a handover to a second cell;
tune away from a traffic channel to a broadcast control channel;
receive a system information message via the broadcast control channel; and
tune back to the traffic channel to continue the connection.

12. The apparatus of claim 11, wherein the system information message is a system information type 3 message.

13. The apparatus of claim 11, wherein the instructions are further executable to camp on the second cell in normal paging mode immediately after the connection ends.

14. The apparatus of claim 11, wherein no more than four bursts of traffic information are missed on the traffic channel while the wireless communication device is tuned to the broadcast control channel.

15. The apparatus of claim 11, wherein tuning away is done in such a manner as to minimize disruption to the connection.

16. The apparatus of claim 11, wherein the connection is a voice call that uses one of half-rate traffic channels and full-rate traffic channels.

17. The apparatus of claim 11, wherein the connection is used for signaling, and wherein the connection is a standalone dedicated channel.

18. The apparatus of claim 11, further comprising starting to monitor a computed paging sub-channel.

19. The apparatus of claim 1, wherein the instructions are further executable to determine frame number information for the second cell from channels used in the connection, wherein the frame number information is used to determine when to tune away from the traffic channel to the broadcast control channel.

20. The apparatus of claim 1, wherein the connection is a circuit switched connection.

21. A wireless device, comprising:
means for beginning a connection via a first cell;
means for participating in a handover to a second cell;
means for tuning away from a traffic channel to a broadcast control channel;
means for receiving a system information message via the broadcast control channel; and
means for tuning back to the traffic channel to continue the connection.

22. The wireless device of claim 21, wherein the system information message is a system information type 3 message.

23. The wireless device of claim 21, further comprising means for camping on the second cell in normal paging mode immediately after the connection ends.

24. The wireless device of claim 21, wherein no more than four bursts of traffic information are missed on the traffic channel while the wireless communication device is tuned to the broadcast control channel.

25. The wireless device of claim 21, wherein tuning away is done in such a manner as to minimize disruption to the connection.

26. A computer-program product for wireless communications, the computer-program product comprising a non-transitory computer-readable medium having instructions thereon, the instructions comprising:
code for causing a wireless communication device to begin a connection via a first cell;
code for causing the wireless communication device to participate in a handover to a second cell;
code for causing the wireless communication device to tune away from a traffic channel to a broadcast control channel;
code for causing the wireless communication device to receive a system information message via the broadcast control channel; and
code for causing the wireless communication device to tune back to the traffic channel to continue the connection.

27. The computer-program product of claim 21, wherein the system information message is a system information type 3 message.

28. The computer-program product of claim 21, wherein the instructions further comprise code for causing the wireless communication device to camp on the second cell in normal paging mode immediately after the connection ends.

29. The computer-program product of claim 21, wherein no more than four bursts of traffic information are missed on the traffic channel while the wireless communication device is tuned to the broadcast control channel.

30. The computer-program product of claim 21, wherein tuning away is done in such a manner as to minimize disruption to the connection.
